(19) United States
(12) Patent Application Publication
(10) Pub. No.: US 2004/0084864 A1
(43) Pub. Date: May 6, 2004

(54) Motorized field cart

(76) Inventors: Darrell Casey, Neosho, MO (US); Darrell Bland, Neosho, MO (US)

Correspondence Address: MCAFEE & TAFT, TENTH FLOOR, TWO LEADERSHIP SQUARE, 211 NORTH ROBINSON, OKLAHOMA CITY, OK, 73102, US

(21) Appl. No.: 10/289,238

(22) Filed: Nov. 6, 2002

(51) Int. Cl. B62B 1/00

(52) U.S. Cl. 280/47.31

(57) ABSTRACT

The current invention provides a motorized single wheel cart. The motorized cart is particularly suited for use in wilderness areas lacking modern roads. The motorized cart has a readily detachable motor and is capable of carrying several hundred pounds of cargo. The motorized cart will readily traverse streams, downed trees and rocks while carrying big game. Additionally, the motorized cart will be useful for search and rescue squads assisting injured hikers and backpackers.

### BACKGROUND OF THE INVENTION

The current invention provides an improved motorized single wheel cart particularly suited for wilderness terrain. Carts of this nature are equally useful for search and rescue missions as well as retrieving game. As an added benefit, one person can easily handle the improved single wheel cart of the current invention.

The remote areas frequented by big game and those in search of big game typically lack modern paved roads. While carts are available for transporting big game, currently available carts typically require two people in order to maneuver a fully loaded cart through the wilderness. While many hunters may use a single base camp, they frequently enter the field alone. Thus, the successful hunter is commonly faced with the difficult task of transporting several hundred pounds of deer, elk or moose over rough terrain to the base camp or a vehicle.

Similarly, hikers and backpackers are frequently injured in remote locations inaccessible by standard search and rescue vehicles. Rescue operations in these areas frequently rely on helicopters to extricate the injured person. However, for non-critical injuries, the use of a helicopter significantly increases search and rescue costs. Additionally, during inclement weather conditions helicopter use increases risks to rescue personnel.

Therefore, a need exists for a cart designed to be operated by a single person and suitable for transporting several hundred pounds over wilderness terrain.

### SUMMARY OF THE INVENTION

The current invention provides an improved single wheel cart. The improved cart comprises a frame defined by at least four frame rails and a wheel carried on an axle. At least two frame rails form the sides of the frame and at least two frame rails join the side frame rails forming the end of the frame. Additionally, the frame has at least one arcuate frame rail joining the side rails. A load carrying means is attached to and positioned within the area defined by the end and side frame rails. A motor located beneath the frame is connected directly or indirectly to the wheel in a manner suitable for driving the wheel. Preferably, the motor is detachably mounted beneath the frame. The axle supporting the wheel is joined to the frame by at least two downwardly projecting supports.

In another embodiment, the current invention provides an improved single wheel cart having a frame defined by at least four frame rails. At least two frame rails form the sides of the frame and at least two frame rails form the end of the frame. The overall length of each side is identical and the overall length of end is identical. Additionally, the frame is generally rectangular in configuration with the sides being longer than the ends. An axle carries the wheel and the wheel and cart additionally carry a brake means for slowing and stopping the cart. The axle is joined to the frame by at least four downwardly projecting supports. Preferably, an axle mount joined to the downwardly projecting supports carries the axle. To provide torsional resistance, at least two arcuate frame rails join the side frame rails to one another. A detachably mounted motor is located beneath the frame. The motor is directly or indirectly connected to the wheel in a manner suitable for driving the wheel. The motor includes a throttle for speed control. A load carrying means is positioned in the area defined by the frame and attached to the frame rails. Finally, extending outwards from at least one end of the frame is at least two handles. Preferably, one handle carries the means for actuating the throttle and the other handle carries the means for actuating the brake means.

In yet another embodiment, the current invention provides an improved single wheel cart comprising a centrally located wheel carried on an axle. Preferably, an axle mount carries the axle. The wheel and cart additionally carry a brake means for slowing and stopping the cart. The cart has a frame defined by at least four frame rails. At least two frame rails form the sides of the frame and at least two frame rails form the end of the frame. The overall length of each side is identical and the overall length of end is identical. Additionally, the frame is generally rectangular in configuration with the sides being longer than the ends. The axle is joined to the frame by at least four downwardly projecting supports. Each downwardly projecting support is secured to the frame at an angle less than 90 degrees. At least two arcuate frame rails, preferably parallel to the end frame rails, join the side rails to increase the torsional strength of the frame. The arcuate frame rails are joined to each other by at least one rigid member. Additionally, the rigid member is optionally joined to the axle or axle mount. The cart further comprises a motor detachably mounted beneath the frame to at least one arcuate frame rail. Preferably, the motor has three motor mounts detachably securing the motor to the cart. The motor engages the wheel, directly or indirectly, in a manner suitable for driving the wheel. The motor includes a throttle for controlling motor speed. A load carrying means is positioned in the area defined by the frame and attached to the frame rails. Finally, handles for maneuvering the cart project outwards from the rails forming the side of the frame. Thus, each end of the cart has at least one pair of handles. Preferably, at least one handle carries the means for actuating the throttle and at least one other handle carries the means for actuating the brake means.

### BRIEF DESCRIPTION OF THE DRAWINGS

FIG. 1 is a perspective view of one embodiment of the current invention.

FIG. 2 is a top view of one embodiment of the current invention.

FIG. 3 is a side view of one embodiment of the current invention.

FIG. 4 is an end view of one embodiment of the current invention.

### DETAILED DESCRIPTION OF THE CURRENT INVENTION

The single wheel cart 10 of the current invention is particularly useful for big game hunters and search and rescue teams. Cart 10 is designed to readily traverse wilderness terrain including downed logs, streams and rocks. The readily detachable motor 38 provides sufficient power to permit operation of cart 10 by a single person. The frame 22 and load carrying means 46 are capable of carrying the weight of a person or even a moose out of a wilderness area. Thus, the current invention provides a significant advance over carts previously available to hunters and search and rescue crews. A detailed description of the preferred embodiment of the current invention will be provided below with reference to the figures.

As depicted in the figures, cart 10 of the current invention comprises a single wheel 14 carrying a tire 16. A preferred wheel 14/tire 16 assembly is a front motorcycle wheel/tire assembly. An axle 18 carries wheel 14. Preferably, an axle mount 20 supports axle 14 and brake means, not shown, for slowing and stopping cart 10. The brake means may be any common type of brake assembly associated with motorcycles or bicycles. Accordingly, disc brakes, drum brakes and even caliper brakes, which engage the wheel, will provide adequate braking for the purposes of the current invention. Brake mechanisms of this type are well known to those skilled in the art.

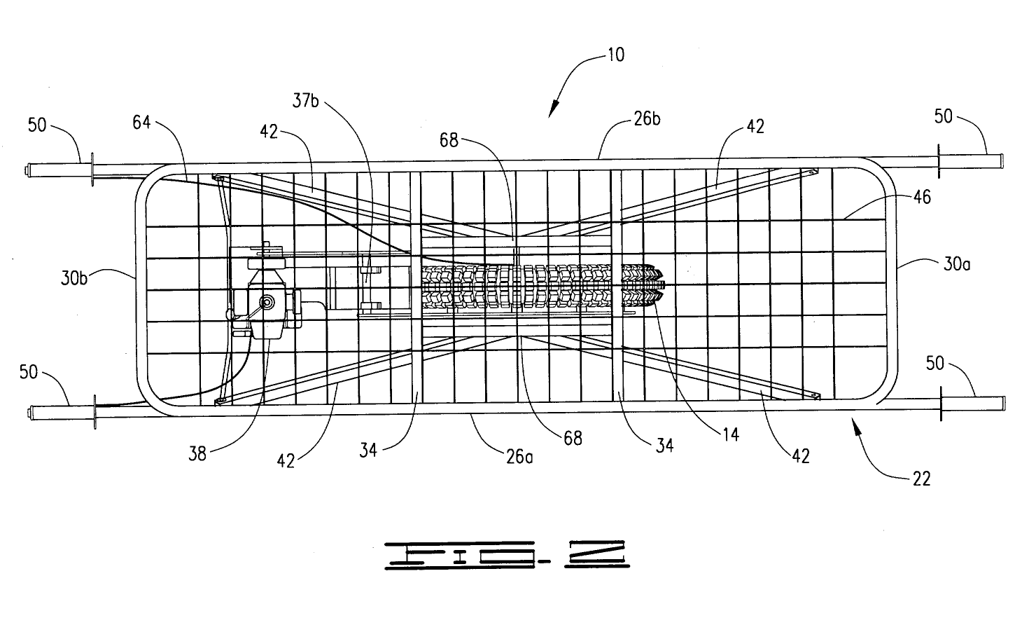

Cart 10 further comprises a frame 22. Frame 22 is defined by at least four frame rails 26a, 26b, 30a and 30b. As shown in FIG. 2, frame 22 is preferably rectangular in shape. However, other configurations may be better suited for specific applications such as search and rescue. As shown, each side rail, 26a and 26b, is a single rail; however, several components may be joined together to form sides 26 and ends 30. End rails 30a and 30b join side rails 26a and 26b to form frame 22. As shown, the rectangular configuration does not necessarily require right angles between side rails 26 and end rails 30. Frame rails 26a, 26b, 30a and 30b may be any conventional material having the strength necessary for cart 10 including but not limited to fiberglass, steel or aluminum tubing, rods or angle bars. The components of frame 22 may be joined by any conventional means including but not limited to welding, screws, rivets and nuts and bolts.

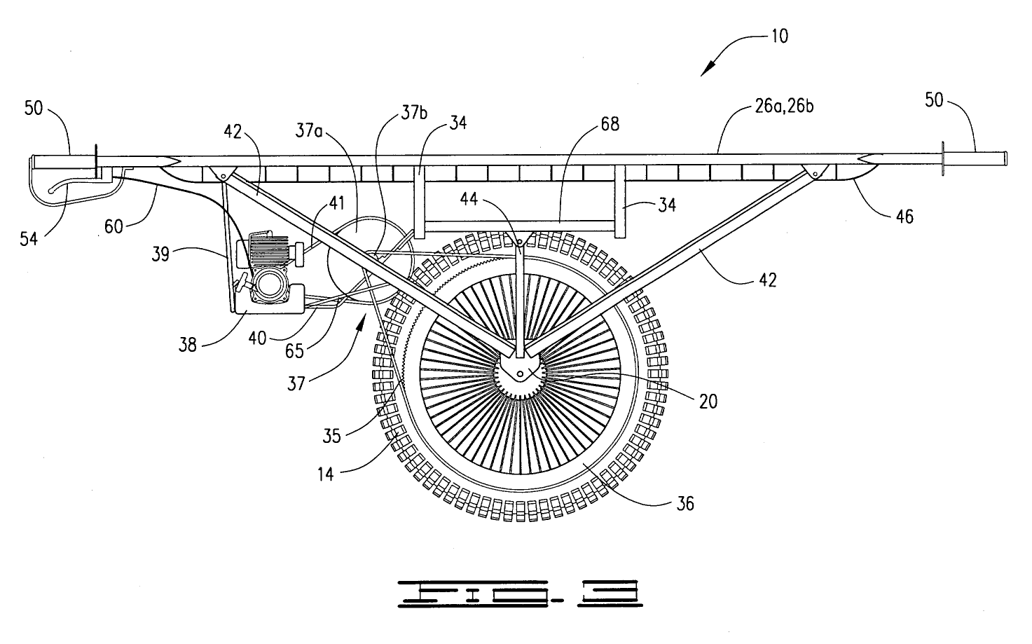

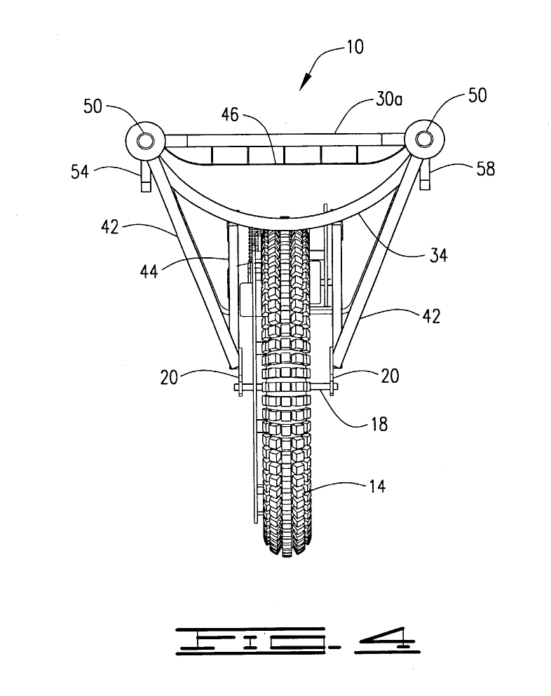

As shown in FIG. 4, torsional rigidity of frame 22 is enhanced by an arcuate frame rail 34 joining side rails 26a and 26b. Preferably, at least two arcuate frame rails 34 join side rails 26a and 26b. In general, arcuate frame rails 34 may be position anywhere along the length of frame 22. When two arcuate frame rails 34 are installed each arcuate frame rail 34 is preferably positioned an equal distance from and parallel to opposing end rails 30a and 30b. To further increase structural rigidity, arcuate frame rails 34 are joined by at least one rigid brace 68. Additionally, as shown in FIG. 3, rigid brace 68 is optionally joined to axle 18 or axle mount 20 by downwardly projecting bracket 44. If axle mount 20 is omitted, then downwardly projecting bracket 44 may also support any of the brake means (not shown) described above.

Frame 22 additionally carries at least two and preferably four downwardly projecting support brackets 42. Preferably, support brackets 42 join axle 18 or axle mount 20 directly to frame 22. Support brackets 42 may be bolted, welded or joined by any other conventional means to frame 22 and axle 18 or axle mount 20. Optionally, brackets 42 and 44 may be joined in a manner to form axle mount 20. Preferably, support brackets 42 attach to frame 22 at an angle less than 90 degrees. Attachment of brackets 42 at an angle of less than 90 degrees provides increased clearance for cart 10 when passing over logs and rocks.

As previously noted, motor 38 is detachably mounted beneath frame 22. Preferably, motor 38 has at least three motor mounts 39, 40 and 65. Motor mounts 39, 40 and 65 secure motor 38 to any convenient location on cart 10. Preferably, mount 40 is detachably secured to at least one arcuate frame rail 34 and mount 39 is detachably secured to either or both frame rails 26a and 26b. Mount 65 reduces twisting of motor 38 by joining mount 40 to downwardly project support bracket 42. Mounts 39, 40 and 65 are secured to the selected location of cart 10 using conventional hardware such as wing nuts, standard nuts and bolts or other hardware which may be readily assembled and disassembled with conventional hand tools. Thus, the ability to quickly removed motor 38 permits use of cart 10 in wilderness areas prohibiting the use of motorized equipment.

Motor 38 transmits power to wheel 14 by any conventional means known to those skilled in the art. Preferably, the means for transmitting power provides cart 10 with a rate of speed approximately equivalent to a walking pace. Thus, at maximum power, the preferred drive mechanism will drive cart 10 at a speed of approximately 3 to 5 miles per hours. In certain applications, such as relatively flat smooth terrain, higher speeds may be desired. Increased speed may be provided by appropriate gearing mechanisms known to those skilled in the art.

Without limiting the current invention to any particular drive mechanism or motor 38, the current invention will be described with regards to a chain drive mechanism and gasoline engine. FIG. 3 depicts motor 38 as either a two stroke or four stroke engine having an output shaft carrying a centrifugal clutch and sprocket (neither are shown). As motor speed increases, the centrifugal clutch engages and transmits power to the sprocket. A chain 41 engages the sprocket and transmits power from motor 38 to a jackshaft 37. Jackshaft 37 comprises a large sprocket 37a joined by shaft 37b to small sprocket 37c. Rotation of sprocket 37a by chain 41 in turn rotates sprocket 37c, which is linked to sprocket 36 by chain 35. Thus, jackshaft 37 and chains 35 and 41 transmit power from motor 38 to wheel 14. Sprocket sizes for motor 38, jackshaft 37 and wheel 14 are preferably chosen to convert maximum engine speed to a forward rate of travel approximately equal to three to six miles per hour. As shown, motor mount 40 supports jackshaft 37. A throttle (not shown) provides the means for controlling engine speed.

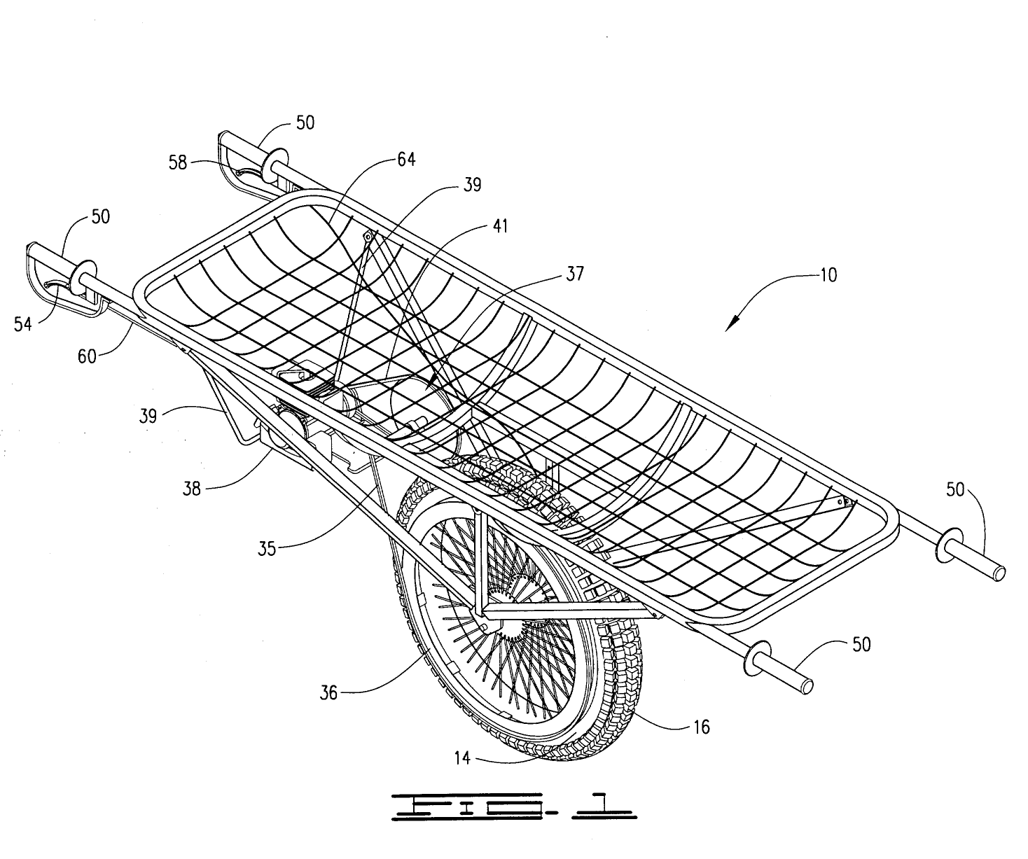

The speed of cart 10 is managed by manipulating the throttle and the brake. Preferably, the mechanisms for controlling the throttle and brake are carried on separate handles 50. As shown in FIG. 1, handles 50 project outwards from frame 22 and provide the means for maneuvering cart 10. Preferably, handles 50 are attached to frame rails 26a and 26b by any conventional means or are extensions of frame rails 26a and 26b. In a preferred embodiment as shown in FIG. 1, each end of cart 10 has at least one pair of handles 50. Preferably, at least one handle 50 carries a means for actuating the throttle such as throttle actuating lever 58. Additionally, at least the other handle 50 of the pair carries the means for actuating the brake means. The means for actuating the brake is a brake actuating lever 54 similar to those commonly found on motorcycles, bicycles and all terrain vehicles. For example, throttle actuating lever 54 is connected to the throttle (not shown) by a cable 60. Similarly, a cable 64 provides the linkage between brake actuating lever 54 and the brake (not shown). Additionally, throttle actuating lever 58 is readily available and is similar to those found on motor cycles, string line trimmers or other equipment utilizing small engines. Throttle actuating lever 58 and brake actuating lever 54 are mounted in a manner conventional on handles 50. Optionally, handles 50 at each end of cart 10 may be equipped with either a brake actuating lever 54 and/or a throttle actuating lever 58 thereby permitting operation from either end of cart 10.

Finally, in order to better retain the object being transported within cart 10, a load carrying means 46 is provided. Load carrying means 46 is positioned within the perimeter defined by frame 22 and attached to frame 22. As shown in the Figs., load carrying means 46 comprises nylon rope. Alternatively, load carrying means 46 may be any material suitable for forming a mesh like support within frame 22 and capable of carrying the desired load. For example metal wire, even chicken wire, may be fitted to frame 22 in order to provide a load carrying means 46. Plastic mesh and other materials will also provide adequate support for many loads. In one embodiment of the current invention, the dimensions of frame 22 will preferably accommodate standard gurneys utilized by search and rescue squads.

While the present invention has been described in detail with reference to FIGS. 1-4, other embodiments of the device will be apparent to those skilled in the art. Thus, the foregoing specification is considered exemplary with the true scope and spirit of the invention being indicated by the following claims.

What is claimed is:

1. An improved single wheel cart comprising:
a single wheel carried on an axle;
a frame defined by at least four frame rails wherein at least two frame rails form the sides of the frame and wherein at least two frame rails form the ends of the frame and wherein the side frame rails are longer than the end frame rails;
at least one arcuate frame rail joining the longer frame rails;
a motor located beneath said frame, said motor directly or indirectly engages said wheel in a manner to transmit a driving force to said wheel; and,
said axle is joined to said frame by at least two downwardly projecting support brackets.

2. The single wheel cart of claim 1, further comprising a load carrying means located between the frame rails.

3. The single wheel cart of claim 2, wherein said load carrying means is rope, wire or plastic.

4. The single wheel cart of claim 1, further comprising a second arcuate frame rail joining the longer frame rails and wherein each arcuate frame rail is positioned equal distance from the center of the frame.

5. The single wheel cart of claim 1, wherein said motor is detachably mounted beneath said frame.

6. The single wheel cart of claim 1, wherein said cart carries a brake means and said engine has a throttle.

7. The single wheel cart of claim 6, wherein said frame has at least two handles wherein one handle carries a means for actuating the brake means and the other handle carries the means for controlling the throttle and said motor is located in the area between said handles and said wheel.

8. The single wheel cart of claim 7, wherein said means for actuating said brake means is a lever connected to said brake means by a cable and wherein said means for actuating said throttle is a lever connected to said throttle by a cable.

9. The single wheel cart of claim 1, wherein said motor is detachably mounted to said cart.

10. The single wheel cart of claim 1, wherein said axle is carried by an axle mount joined to said frame by at least two downwardly projecting support brackets.

11. The single wheel cart of claim 1, wherein said axle is carried by an axle mount joined to said frame by at least four downwardly projecting support brackets.

12. The single wheel cart of claim 1, wherein said axle is carried by an axle mount joined to said frame by at least six downwardly projecting support brackets.

13. An improved single wheel cart comprising:
a single wheel carried on an axle;
a brake means;
a rectangular frame defined by at least four frame rails wherein at least two frame rails form the sides of the frame and at least two frame rails form the ends of the frame, wherein the side frame rails are of equal length and the end frame rails are of equal length, and wherein the side frame rails are longer than the end frame rails;
said axle is joined to said frame by at least four downwardly projecting support brackets;
at least two arcuate frame rails joining the longer frame rails;
a motor located beneath said rectangular frame, said motor directly or indirectly engages said wheel in a manner to transmit a driving force to said wheel;
said motor including a throttle for controlling motor speed;
said motor being detachably mounted beneath said rectangular frame;
a load carrying means positioned between said frame rails; and,
said frame having at least two handles wherein one handle carries a means for actuating the brake means and the other handle carries the means for controlling the throttle.

14. The single wheel cart of claim 13, wherein said load carrying means is rope, wire or plastic.

15. The single wheel cart of claim 13, having two arcuate frame rails joining the longer frame rails and wherein said arcuate frame rails are positioned equal distance from the end frame rails.

16. The single wheel cart of claim 13, wherein said axle is carried by an axle mount joined to said frame by at least four downwardly projecting supports.

17. The single wheel cart of claim 13, wherein said axle is carried by an axle mount joined to said frame by at least six downwardly projecting supports.

18. The single wheel cart of claim 13, wherein said motor is mounted in the area between said handles and said wheel and said motor is carried by at least two motor mounts, wherein at least one motor mount is detachably attached to at least one arcuate frame rail and at least one other motor mount is detachably attached to at least one other attachment point on said cart.

19. The single wheel cart of claim 18, wherein said other attachment point is selected from a downwardly projecting support, a side frame rail and an end frame rail.

20. The single wheel cart of claim 13, wherein said means for actuating said brake means is a lever connected to said brake means by a cable and wherein said means for actuating said throttle is a lever connected to said throttle by a cable.

21. An improved single wheel cart comprising:
a single wheel carried on an axle;
a brake means;
a rectangular frame defined by at least four frame rails wherein at least two frame rails form the sides of the frame and at least two frame rails form the ends of the frame, wherein the side frame rails are of equal length, and wherein the side frame rails are longer than the end frame rails;
said axle is joined to said frame by at least four downwardly projecting supports brackets, said support brackets secured to said rectangular frame at an angle less than 90 degrees;
at least two arcuate frame rails, parallel to said end frame rails and joining the longer frame rails, said arcuate frame rails being joined to each other by at least one rigid member, said rigid member being joined by a vertical member to said axle;
a motor located beneath said rectangular frame, said motor directly or indirectly engages said wheel in a manner to transmit a driving force to said wheel;
said motor including a throttle for controlling motor speed;
said motor carried by at least one motor mount, wherein in at least one motor mount is detachably attached to at least one arcuate frame rail;
a load carrying means located between the frame rails;
a handle projecting outwardly from each end of each long frame rail thereby forming a pair of handles at each end of said cart, wherein within at least one pair of handles one handle carries a means for actuating the brake means and the other handle of the pair carries a means for controlling the throttle.

22. The single wheel cart of claim 21, wherein said load carrying means is rope, wire or plastic.

23. The single wheel cart of claim 21, having two arcuate frame rails joining the longer frame rails and wherein said arcuate frame rails are positioned equal distance from the end frame rails.

24. The single wheel cart of claim 21, wherein said axle is carried by an axle mount joined to said frame by at least four downwardly projecting supports.

25. The single wheel cart of claim 21, wherein said axle is carried by an axle mount joined to said frame by at least six downwardly projecting supports.

26. The single wheel cart of claim 21, wherein said motor is mounted in the area between said handles and said wheel and said motor is carried by at least two motor mounts, wherein at least one motor mount is detachably attached to at least one arcuate frame rail and at least one other motor mount is detachably attached to at least one other attachment point on said cart.

27. The single wheel cart of claim 21, wherein said other attachment point is selected from a downwardly projecting support, a side frame rail and an end frame rail.

28. The single wheel cart of claim 21, wherein said means for actuating said brake means is a lever connected to said brake means by a cable and wherein said means for actuating said throttle is a lever connected to said throttle by a cable.
